(19) United States
(12) Patent Application Publication
(10) Pub. No.: US 2015/0213413 A1
(43) Pub. Date: Jul. 30, 2015

(54) Employment Server and Methods

(71) Applicants: Kamyar Faron, Los Altos, CA (US); Jonathan P Tsai, Fremont, CA (US)

(72) Inventors: Kamyar Faron, Los Altos, CA (US); Jonathan P Tsai, Fremont, CA (US)

(21) Appl. No.: 14/608,178

(22) Filed: Jan. 28, 2015

Related U.S. Application Data
(60) Provisional application No. 61/944,027, filed on Feb. 24, 2014.
(60) Provisional application No. 61/932,627, filed on Jan. 28, 2014.

(51) Int. Cl. G06Q 10/10

(52) U.S. Cl. CPC G06Q 10/1053

(57) ABSTRACT

Disclosed is an employment application system that allows a user to provide data to a common application form and then use that data to apply for employment opportunities at a wide range of employers. Logic is used to select fields from the common application form to populate fields of a custom, e.g., opportunity specific, application form of the employer. Optional features include automatic detection of an applicant's location and search for opportunities proximate to that location.

### CROSS-REFERENCE TO RELATED APPLICATIONS

This application claims benefit of and priority to U.S. provisional patent application Ser. No. 61/932,627 filed Jan. 28, 2014 and U.S. provisional patent application Ser. No. 61/944,027 filed Feb. 24, 2014. The disclosures of the above provisional patent applications are hereby incorporated herein by reference.

### BACKGROUND

1. Field of the Invention

The invention is in the field of employment application processing, and specifically in the field of using automated systems to provide improved communication of employment opportunities.

2. Related Art

Today's practices require job seekers to fill out a unique employment application for every opportunity while the significant majority of the requested information on these applications is identical. This is a very redundant, inefficient and time-consuming process. The employers, on the other hand, are faced with challenges of finding the right candidates for their open positions and are routinely looking for ways to reduce the barriers for qualified passive candidates to submit applications.

Further, while employment opportunities are currently available online, it is typically very difficult to search for jobs within a small geographical area such as a neighborhood or a few city blocks. This still requires walking from business to business and filling out different applications for each job. There is a need for improved systems that automate and streamline the identification of employment opportunities and employment applications.

### SUMMARY

Various embodiments of the invention include computer and internet based systems that improve the processes of employment opportunity communication and/or application for employment. Employment opportunities may be provided as a function of an applicant's physical location, which is determined using a global positioning system or by receiving identification information that is associated with a specific location. The location is used to select employment opportunities in a limited geographic area. The selected opportunities are presented to the applicant and the applicant can automatically apply to one or more of the opportunities by requesting that a previously stored applicant profile be communicated to prospective employers.

The employment opportunities presented to an applicant may be from different employers. This could result in the technical problem that effort expended by one employer to attract employees results in an applicant receiving an employment opportunity at a competitor. In some embodiments, this problem is resolved by controlling the employment opportunities presented to the applicant as a function of how the applicant connected with the system. For example, if an applicant connects to the system from a source proprietary to an employer, such as the employer's website, then the employment opportunities presented to the applicant may be limited to that employer. If an applicant connects to the system using a barcode (e.g., a QR code) located on a generic advertisement, then the presented opportunities may include jobs from different employers, optionally located near that generic advertisement.

A variety of different approaches may be used to identify the location of an applicant. For example, in some embodiments, the global positioning capabilities of a phone or other mobile device are used to identify the location of the device. In some embodiments, a QR code, universal resource locator (URL) or other identifier is used to indicate both a location and a specific employer. In various embodiments, other tools are used to identify locations and/or employers. These may include digital maps, image recognition, addresses, and/or the like.

Various embodiments of the invention include an employment application system configured to streamline the employment application process. For example the employment application system enables job seekers to pre-fill one common employment application and apply to available opportunities using any device (smart phone, tablet, laptop, etc.) with only a few clicks. Once the common employment application is completed, applicants can apply to an employment opportunity using a single click. Data from the common employment application is automatically used to populate data fields in custom employment applications specified by individual employers. Some of these data fields are assigned to one of the plurality of employment opportunities but not others from the same employer.

Various embodiments of the invention include an employment application system to provide multiple employment opportunities, the system comprising an input/output configured to communicate to and from a remote client; memory including a data structure configured to store a plurality of applicant profiles, a data structure configured to store data regarding a plurality of employers, the data regarding the plurality of employers including a plurality of employment opportunities offered by the employers, a data structure configured to store a plurality of source identifiers, each of the source identifiers being associated with at least one of the employers; listing logic configured to receive a request for one or more employment opportunities, to retrieve the requested employment opportunities from the second memory, and to provide the retrieved employment opportunities to the remote client; application logic configured to receive a request for employment from the remote client, the request being in response to one of the retrieved employment opportunities, and further configured to retrieve a first of the plurality of applicant profiles from the first memory and to send the first of the plurality of applicant profiles to an employer in response to receiving the request for employment, the one of the retrieved employment opportunities being for employment at the employer; source logic configured to identify a source of the request for employment opportunities by comparing received source information to the source identifiers and from the third memory and to determine whether or not the source is an employer proprietary source; listing selection logic configured to select another employment listing and automatically provide the selected employment listing to the remote client, the selection of another employment listing being based on the determination of whether or not the source is an employer proprietary source; and a microprocessor configured to execute at least the listing selection logic.

Various embodiments of the invention include a method of providing an employment referral, the method comprising: receiving, via a communication network, an applicant profile including information characterizing a person; storing the applicant profile in a memory, the memory including a data structure configured to store multiple applicant profiles; receiving a request for a first employment opportunity from a remote client device, the request including a source identifier; retrieving the first employment opportunity from a computer memory, the memory including a data structure configured to store multiple employment opportunities; providing to the client device the first employment opportunity, the first employment opportunity being for employment at a first employer; receiving a first request for employment from the client device, the first request being responsive to the first employment listing; providing the applicant profile to the first employer; identifying a source of the first request; confirming that the source of the request is not an employer proprietary source; optionally selecting a second employment listing based on whether or not the source identifier does or does not identify an employer propriety source; and automatically providing a second employment opportunity to the client device, responsive to the source of the request not being an employer proprietary source, the second employment opportunity being for employment at a second employer.

Various embodiments of the invention include an employment application server comprising: an I/O configured to communicate to and from a remote client; first memory including a data structure configured to store a plurality of applicant profiles; second memory including a data structure configured to store a plurality of employment opportunities offered by a plurality of employers; third memory including a data structure configured to store a plurality of source identifiers, each of the source identifiers being associated with at least one of the employers and being associated with a location; listing logic configured to receive a request for employment opportunities, to retrieve the requested employment opportunities from the second memory, and to provide the retrieved employment opportunities to the remote client, the request for employment opportunities being received along with source information configured to identify a location of the remote client; application logic configured to receive a request for employment from the remote client, the request being in response to one of the retrieved employment opportunities, and further configured to retrieve a first of the plurality of applicant profiles from the first memory and to send the first of the plurality of applicant profiles to an employer in response to receiving the request for employment, the one of the retrieved employment opportunities being for employment at the employer; and a microprocessor configured to execute at least the listing logic.

Various embodiments of the invention include a method of providing location based employment information, the method comprising: receiving, via a communication network, an applicant profile including information characterizing a person; storing the applicant profile in a memory, the memory including a data structure configured to store multiple applicant profiles; receiving a request for one or more employment opportunities from a remote client, the request including a source information; identifying a location of the client device based on the source information; retrieving the one or more employment opportunities from a computer memory, the computer memory including a data structure configured to store multiple employment opportunities, retrieval of the one or more employment opportunities being based on the location of the client device; providing to the client device the one or more employment opportunities, the one or more employment opportunities including an employment opportunity at a facility proximate to the location of the client device; receiving a first request for employment from the client device, the first request being responsive to the employment opportunity at the facility proximate to the location of the client; and providing the applicant profile to an employer of the employment opportunity at the facility.

### BRIEF DESCRIPTION OF THE DRAWINGS

FIG. 1 illustrates an employment application system, according to various embodiments of the invention.

FIG. 2 illustrates methods of providing employment opportunities, according to various embodiments of the invention.

FIG. 3 illustrates further applicant related components that may be included in an employment application system, according to various embodiments of the invention.

FIG. 4 illustrates further employer related components that may be included in an employment application system, according to various embodiments of the invention.

### DETAILED DESCRIPTION

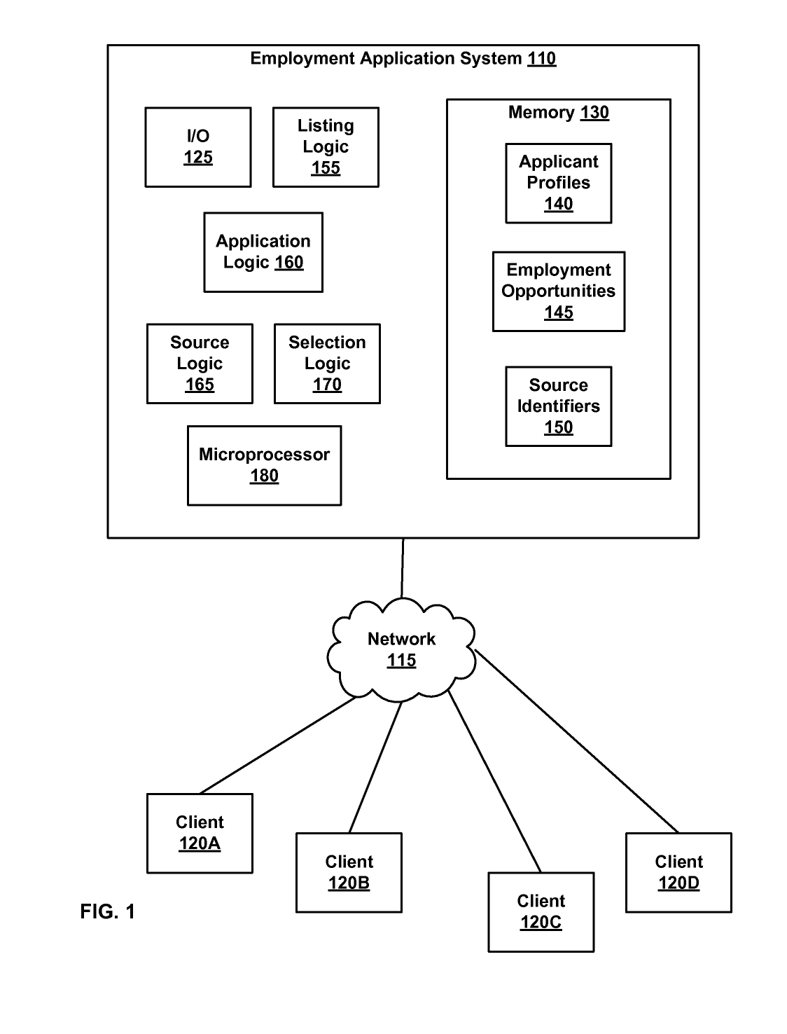

FIG. 1 illustrates an Employment Application System 110, according to various embodiments of the invention. Employment Application System 110 is configured to communicate with multiple Clients 120 via a Network 115. Employment Application System 110 includes one or more computing devices specifically configured to perform the various functions described herein. These computing devices may be disposed in one location or may be geographically distributed. Network 115 includes a communication network such as a telephone network, a computer network, a cellular network, and/or the Internet. Communication within Network 115 is optionally performed using data packs according to TCP/IP protocols.

Clients 120 are individually designated 120A, 120B, 120C, etc. Clients 120 are typically disposed at different locations and can include personal computers and/or mobile devices. In some embodiments, Clients 120 include smart phones configured to execute a browser or a specific application program (app), which in turn is configured to communicate with Employment Application System 110 via Network 115. As used herein, the term “location” is meant to specifically refer to geographic locations such as a city, town, street, building, etc.

As illustrated in FIG. 1, Employment Application System 110 includes an I/O 125 (input/output) configured to communicate with Clients 120 via Network 120. I/O 125 includes hardware such as a modem, Ethernet port, router or firewall. I/O 125 optionally further includes logic configured to read and write data to memory locations, and/or an application programming interface (API) configured to communicate with external applications. For example, I/O 125 may include an application programming interface configured to communicate with an application executing on one or more of Clients 120.

Employment Application System 110 further includes Memory 130. Memory 130 is non-transient computer readable storage configured to store data and/or computing instructions. Memory 130 may be disposed within a single computing device or be distributed among multiple devices. Memory 130 can include, for example, a hard drive, an optical drive, read-only memory, random access memory, static memory, or any combination thereof. Memory 130 is optionally managed by a file or database system. Generally, Memory 130 is configured to store data through the use of specific data structures configured to hold specific data types. For example, Memory 130 is configured to store Applicant Profiles 140 including information relating to job applicants. This information can include name, account information, work history, job application history, recommendations, contact information, associated members of Clients 120, past locations, and/or the like. This information is stored in one or more data structures configured to store data of datatypes corresponding to the respective information and configured for easy retrieval of the information. In some embodiments, Applicant Profiles 140 include data sufficient to populate a generic common application form. This common application form is meant to include a superset or logical union of fields found in numerous custom employer specified application forms and thus be sufficient to populate the custom application forms. Typically, Memory 130 is configured to store Applicant Profiles 140 for numerous job applicants.

Memory 130 further includes a data structure configured to store Employment Opportunities 145. Employment Opportunities 145 are data characterizing listings of available jobs for which a (job) applicant can apply. Employment Opportunities 145 include, for example, a location, a type of job, application requirements, an employer, pay range, and/or the like. In some embodiments, Employment Opportunities 145 include a data describing a job as a server at a restaurant located in downtown Palo Alto, Calif. This job is associated with a specific employer (who may have provided the listing data to Employment Application System 110) and optionally with a specific employment facility, e.g., location. The “employment facility” is the building and/or physical location at which the employment would occur. Employment Opportunities 145 optionally include a customized specification of what data is required and/or can be acceptable as part of an application for employment. For example, Employment Opportunities 145 can specify that a specific subset of information within Applicant Profiles 140 is required to apply for employment. This specific subset may vary between different Employment Opportunities 145, even for the same employer.

Employment Opportunities 145 optionally include, or are associated with, information regarding a plurality of employers. For example, they may include employer contact information, hiring history, multiple employment locations, number of employees, number of employment opportunities open, and/or the like. One of Employment Opportunities 145 for work at a specific hotel may be associated with a list of all employment opportunities available from hotels with the same hotel chain and locations of employment facilities (hotels) for the hotel chain. In some embodiments, Memory 130 includes a data structure configured to store data regarding a plurality of employers, the data regarding the plurality of employers including a plurality of Employment Opportunities 145 offered by the employers.

Memory 130 further includes a data structure configured to store a plurality of Source Identifiers 150. Each of Source Identifiers 150 is associated with at least one employer and is configured for identifying a source of a request for Employment Opportunities 145 by comparing data, referred to as source information, to the Source Identifiers 150. The source information is received contemporaneously to receipt of a request for Employment Opportunities 145.

Source Identifiers 150 are optionally each associated with a specific location and/or facility. A “request source” is the information or device by which a member of Clients 120 connects to employment Application System 110 for a specific interaction session. Examples of request sources include a physical location, a zip code, a webpage, a specific facility, a specific employer, a specific remote client, a physical address, a particular piece of advertising collateral, and the like. Examples of Source Identifiers 150 include network address (such as an Internet Protocol (IP) address, MAC address or Universal Resource, Locator (URL)), GPS data, a MAC address of a mobile device or a wireless router, a wireless network identifier, an SSID, a barcode (and code embedded therein), a physical address (e.g., street and number), cellular tower data, a photograph of a facility, a phone number, and the like. For Example, a specific facility may be identified by an advertisement including a barcode posted on a store front, a specific URL printed on an advertisement or a business card, or a photograph of the facility. A specific facility may alternatively be identified by first identifying the location of the member of Clients 120 from which a request is received and then identifying the facility proximate to that location. In some embodiments, a photograph of a business is used as an identifier to be processed by image recognition software so as to identify the particular business or facility. In some embodiments, internet links (e.g. URLs) including specific information (e.g. an alphanumeric code) identifying a source website are used as Source Identifiers 150 to identify the source website. As used herein, “barcode” is used to refer to barcodes, QR codes, 3D QR code or other symbol encoding information.

Multiple Source Identifiers 150 are optionally used in combination. For example, a picture of a chain restaurant may be used to identify the chain, and cellular tower data then used to identify a geographic region. The combination of the identified chain and the geographic region can then be used together to identify a specific restaurant within the chain. With the benefit of this disclosure it will be apparent to one of ordinary skill in the art that Source Identifiers 150 can include a wide variety of information.

Source Identifiers 150 (and corresponding source information) optionally characterize a general or an employer proprietary source. For example, a Source Identifier 150 that includes merely a geographic location is typically considered a general source. In comparison, a Source Identifier 150 that matches a URL and code (e.g., QR code) on a business card or a link on a corporate (employer) website would normally be considered an employer proprietary source. In some embodiments, a storefront display including encoded source information is considered an employer proprietary source while in other embodiments it is considered a general source. As is discussed further elsewhere herein, the optional classification of sources into two or more types can be used to determine how requests for Employment Opportunities 145 are processed. An employer may desire that requests are processed differently depending on their classification.

The Source Identifiers 150 may be specific to a location and/or to an employer. For example, a request may include a current location of Client 120A (or a map location) and not include any employer specific information. In some embodiments, this request will be interpreted as being for Employment Opportunities 145 within a fixed distance of the location. A request may include an alphanumeric code embedded in a barcode (e.g., QR code) posted on a business door or code within a URL included on a business card. Such a request will be treated as a request for Employment Opportunities 145 at a specific location and/or employer. Requests may be both employer and location specific.

Employment Application System 110 further includes Listing Logic 155. Listing Logic 155 is configured to receive a request for one or more Employment Opportunities 145 from a member of Clients 120. In response to receiving the request, Listing Logic 155 is further configured to retrieve the requested Employment Opportunities 145 from Memory 130. The retrieved Employment Opportunities 145 may then be provided to the member of Clients 120 from which the request was received. As discussed further elsewhere herein, selection of which of Employment Opportunities 145 to provide to the member of Clients 120 is optionally dependent on a location or other source information, e.g., the location of the member of Clients 120.

The requests for one or more Employment Opportunities 145 include source information that can be compared with Source Identifiers 150 and include the comparable (e.g., matching) data types. For example, the source information can include network address (such as an Internet Protocol (IP) address, MAC address or Universal Resource, Locator (URL)), location information, GPS data, a MAC address of a mobile device or a wireless router, a wireless network identifier, an SSID, a barcode (and code embedded therein), a physical address (e.g., street and number), cellular tower data, a photograph of a facility, and/or the like. The source information is matched with Source Identifiers 150, which are in turn used to retrieve Employment Opportunities 150 having matching criteria. For example, if the source information in a request includes a location then Employment Opportunities 145 within a predetermined distance of that location may be retrieved. If the source information in a request includes an identifier of a specific facility, then Employment Opportunities 145 at that facility are retrieved. In some embodiments, the source information is used to identify one, two or more Source Identifiers 150 and the identified Source Identifiers 150 are then used individually or as a group to query a database of Employment Opportunities 145. The source information received with a request optionally includes data configured to extract a location from Memory 130. For example, the source information may include a code (e.g., digital identifier) configured for looking up a location stored in Memory 130. Thus, a storefront barcode can be used to identify a location of the storefront and that location can then be used to identify nearby Employment Opportunities 145.

Employment Application System 110 further comprises Application Logic 160 including features that allow an applicant to automatically apply for a job. Specifically, Application Logic 160 is configured to receive requests for employment from members of Clients 120. The requests are in response to one or more Employment Opportunities 145 previously provided to the member of Clients 120 by Listing Logic 155. Application Logic 160 is further configured to retrieve Applicant Profiles 140 from Memory 130 and to send the retrieved Applicant Profiles 140 to an employer in response to receiving the request. For example, an applicant using Client 120A can review Employment Opportunities 145 provided by Listing Logic 155 and make a request to apply for one or more of the Employment Opportunities 145. In response to this request, Application Logic 160 is configured to retrieve the applicant's profile from Applicant Profiles 140 and to send the applicant's profile to the employer(s) that provided the particular Employment Opportunities 145, the Employment Opportunities 145 being for employment at the employer(s). Note that the employer may have specified that a particular subset of the applicant's profile be retrieved and that the data in that subset be used to populate a customized or employer specific employment application form.

The request to apply for one or more of the Employment Opportunities 145 may be made by clicking on a link in a web page, or by executing a command in an application executing on Clients 120. In some embodiments, Applicant Logic 160 is configured for an applicant to modify or customize their user profile for particular employers. For example, Applicant Logic 160 may be configured to provide a customized cover letter or resume to specific employer(s).

Employment Application System 110 further includes Source Logic 165 configured to identify a source of requests for Employment Opportunities 145. Source Logic 165 is configured retrieve Source Identifiers 150 from Memory 130 using source information included in or received along with the requests. In some embodiments, Source Logic 165 is configured to determine a type of the request and/or source based on the retrieved Source Identifiers 150. For example, Source Logic 165 may be configured to determine whether or not the source is an employer proprietary source. In some embodiments, Source Logic 165 includes a query engine configured to query a database of Source Identifiers 150. In some embodiments, Source Logic 165 is configured to determine a location of Client 120A based on source information received as part of a request. For example, source information can be matched to Source Identifiers 150 (as discussed elsewhere herein) and the matched Source Identifiers 150 may be previously associated with a known location or particular business. Client 120A can then be assumed to be at that location. In a specific example, if the request from Client 120A includes QR code data from a QR code known to be displayed on a specific storefront, then it can be assumed that Client 120A is at that storefront. The barcode data and location of the storefront are optionally included in Source Identifiers 150.

Employment Application System 110 optionally further comprises Selection Logic 170 configured to select Employment Opportunities 145 for presentation to an applicant at Client 120A. This selection may be in response to a received request for employment or may be performed automatically after an applicant reviews a first set of Employment Opportunities 145. The Employment Opportunities 145 are typically selected based on a variety of factors such as source information, location, Employment Opportunities 145 previously applied to by the applicant, and/or a determination of whether or not the source of a request was an employer proprietary source. In one example, if an applicant previously applied for food service positions, Selection Logic 170 may automatically select and present (to the applicant) additional Employment Opportunities 145 related to food service. In another example, if a source of a request is determined to be an employer proprietary source, then Selection Logic 170 is optionally configured to select only other Employment Opportunities 145 associated with the same employer. As such, if the source of the request is an employer's website, Selection Logic 170 can be configured to avoid sending an applicant Employment Opportunities 145 at competitors during the current interaction session. If the source of a request is not an employer proprietary source then Employment Opportunities from multiple employers may be selected, and provided to Client 120A.

Selection Logic 170 is optionally further configured to select Employment Opportunities 145 for provision to Clients 120 based on a location. For example, if an applicant has applied for one of Employment Opportunities 145 at a first location, then Selection Logic 170 may be configured to select additional Employment Opportunities 145 proximate to or within a fixed distance of the first location. As such, an applicant can apply for a job and then automatically receive additional Employment Opportunities 145 in the same neighborhood, zip code, street, or city block, etc. The additional Employment Opportunities 145 are optionally selected as to be relevant to the applicant's background as reflected in their applicant profile. The most relevant profiles may be prioritized.

The actions of Selection Logic 170 are optionally performed in response to receiving a request from Client 120A, an applicant requesting details about one of Employment Opportunities 145, an applicant viewing one of Employment Opportunities 145, and/or an applicant applying for one of Employment Opportunities 145. In some embodiments, Selection Logic 170 is configured to wait until an applicant has made a request for employment, e.g., applied for one of Employment Opportunities 145, before selecting and providing additional Employment Opportunities 145 to the applicant at one of Clients 120.

Employment Application System 110 further comprises at least one Microprocessor 180. Microprocessor 180 is a digital logic device configured to execute at least Selection Logic 170, such that the operation of Selection Logic 170 can be performed automatically, e.g. without need for human action or intervention.

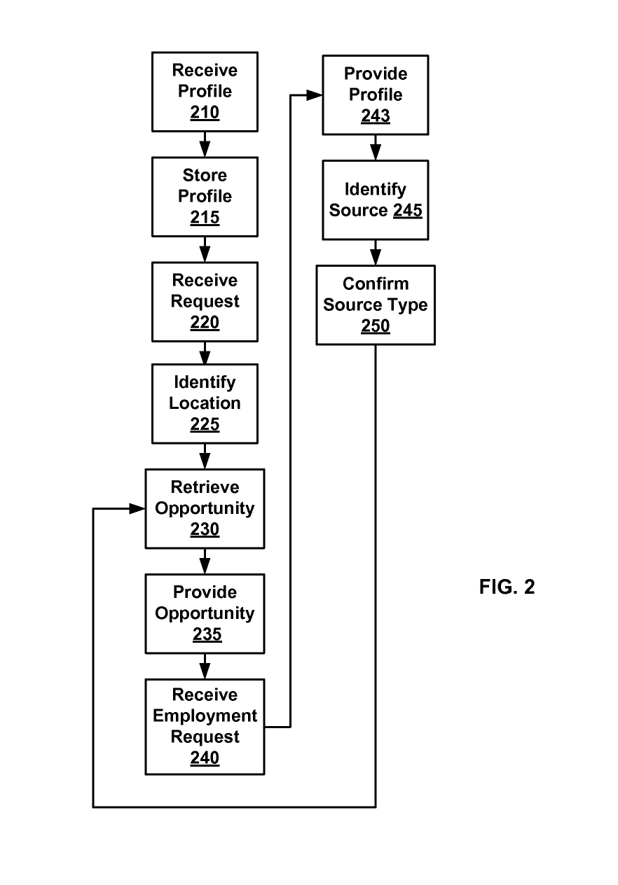

FIG. 2 illustrates methods of providing Employment Opportunities 145, according to various embodiments of the invention. These methods illustrate two optional features of Employment Application System 110. A first feature includes selecting Employment Opportunities 145 for presentation to an applicant as a function of how an applicant initiated a session with Employment Application System 110. This selection is based on the source of a request for Employment Opportunities 145. A second feature includes selecting Employment Opportunities 145 based on a location. This allows an applicant to view Employment Opportunities 145 proximate to a specific location, such as their current location. Either or both of these features can be found in various embodiments of the invention. As used herein, “session” is used to refer to a time during which a program accepts input and processes information, or a time during which two computing devices maintain a communication connection.

In a Receive Profile Step 210 an applicant's (person's) profile is received. This profile includes information characterizing the applicant such as would be used in a job application. Examples of this information include skills, education, employment history, contact information, and/or the like. The applicant profile can be received from a member of Clients 120 and/or through other communication paths. In some embodiments, part of the profile is generated by logging activities (e.g., hiring) that occur using Employment Application System 110.

In a Store Profile Step 215 the received applicant profile is stored in Memory 130 as one of Applicant Profiles 140. This storage is optionally performed using a database management system. Receive Profile Step 210 and Store Profile Step 215 are optionally repeated to update an applicant's profile or to add profiles of additional applicants.

In a Receive Request Step 220 a request for Employment Opportunities 145 is received from Client 120A. As noted elsewhere herein, the request includes source information (an identifier) that can be used to identify the source of the request, such as a location, website, or barcode data.

In an optional Identify Location Step 225 the location associated with the request is derived using the source information. This step is optionally performed using Source Logic 165 and Source Identifiers 150. For example, in some embodiments the source information includes barcode data generated from a barcode on an advertisement. The previously known location of this advertisement is then assumed to be the location used in subsequent steps.

In a Retrieve Opportunity Step 230 one or more Employment Opportunities 145 are retrieved from Memory 130. The retrieved Employment Opportunities 145 are optionally selected using Selection Logic 170 and the source information received with the request. For example, the Employment Opportunities 145 may be selected based on the location, based on an employer, and/or based on other characteristics of each of Employment Opportunities 145. Retrieve Opportunity Step 230 is optionally performed using a database query. In some embodiments, the retrieved Employment Opportunities 145 include an employment opportunity at a facility proximate to the location of Client 120A.

In a Provide Opportunity Step 235, the one or more retrieved Employment Opportunities 145 are provided to Client 120A via Network 115. At Client 120A they are typically presented to the applicant for review and consideration.

In a Receive Employment Request Step 240, a request for employment is received from Client 120A. The request for employment is a request to apply for one of the Employment Opportunities 145 provided in Provide Opportunity Step 235. In some embodiments, requests to apply for several different Employment Opportunities 145 are received together.

In a Provide Profile Step 243 the applicant's profile is retrieved from Applicant Profiles 140 and provided to the employer associated with the member of Employment Opportunities 145 for which the request was received. As noted elsewhere herein, the employer may have previously designated that they wish to receive a specific subset of an applicant's profile in a customized and/or employer designated employment application form. If data needed to populate custom these fields is not available from the common application form, then an applicant is optionally requested to complete the custom fields at the time of application.

In an optional Identify Source Step 245 the source of the request is identified. Identify Source Step 245 is performed using Source Logic 165 and Source Identifiers 150, and is optionally performed as part of Identify Location Step 225 and/or prior to Retrieve Opportunity Step 230. As discussed elsewhere herein, the request source is optionally identified by comparing source information received with the request to Source Identifiers 150 stored in Memory 130. The request source is identified by the matching member(s) of Source Identifiers 150. The matching members of Source Identifiers 150 are optionally used in Retrieve Opportunity Step 230 to define selection criteria for Employment Opportunities 145.

In an optional Confirm Source Type Step 250 the type of the source identifier is identified. In some embodiments the possible types include employer proprietary and general (non-proprietary) Source Identifiers 150. In some embodiments, if the Source Identifiers 150 are confirmed to not identify an employer proprietary source, then Employment Opportunities 145 from other employers can be sent to the applicant. Likewise, if the Source Identifier 150 are confirmed to include an employer proprietary source then, in the current session, the applicant is only referred to Employment Opportunities 145 from the same employer. The Employment Opportunities 145 are selected and sent by repeating steps 230 and 235. The source Identifier type is optionally used in the repetition of Retrieve Opportunity Step 230 as part of the selection criteria for the Employment Opportunities 145 retrieved. The applicant may then apply for a job represented by the additional Employment Opportunities 145 provided in the second performance of Provide Opportunity Step 235.

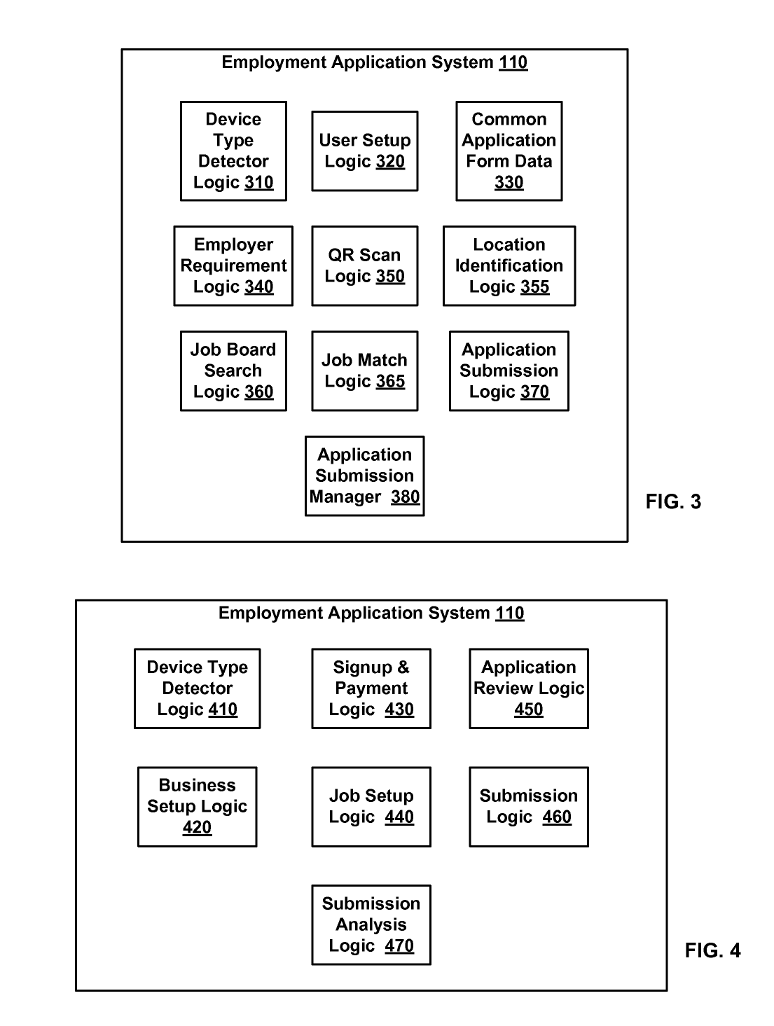

FIG. 3 illustrates further components that may be included in Employment Application System 110, according to various embodiments of the invention. These components include Device Type Detector Logic 310, User Setup Logic 320, Common Application Form Data 330, Master Element Management Logic 335, Employer Requirement Logic 340, QR Scan Logic 350, Location Identification Logic 355, Job Board Search Logic 360, Job Match Logic 365, Application Submission Logic 370, and/or Application Submission Manager 380. These components are configured to allow job seekers to prepare an employment application package that may include: an employment application, a resume, a cover letter, and/or a link to an online profile of the applicant (i.e. a rich media profile). The applicant is able to prepare a master version of each of the above elements and apply to any position in the system with only one click. The applicant (job seeker) is also able to use the master copy of their profile as base of each element and modify each element to best address the requirements of a specific job opportunity.

Device Type Detector Logic 310 is configured to automatically detect the type of device that the applicant is using to access Employment Application System 110, e.g., the type of Client 120A. Employment Application System 110 then automatically adjusts to provide the best user experience for the particular device (mobile and tablet in either portrait and landscape mode as well as laptop or desktop browsers).

User Setup Logic 320 is configured to minimize data entry and entered data (name, contact info, etc.) is optionally used to eliminate any redundant entry yet maintain maximum security. Using User Setup Logic 320 the user is then able to populate the Common Application Form Data 330, which is part of their Applicant Profile 140. This data includes, for example, basic identity information, a picture and/or video, availability for work times, educational history, prior work experience, personal references, driving record, licenses/permits, (130), and/or the like. Applicants are able to create an account and populate the Common Application Form Data 330. The data may include a photo and a short video in addition to all customary employment application contents. The applicants are able upload a master resume onto their account and are able to create a master cover letter. The master documents can be updated or customized for every application package that they submit.

Master Element Management Logic 335 is configured for users to upload their master resume, cover letter, and online profiles from members of Clients 120 to Employment Application System 110. This logic optionally also serves these elements at the application submission time and is responsible for version management.

Employer Requirement Logic 340 is configured for serving and managing the information the applicant provides in response to the specific sections required for each job. This logic is invoked at the time of application submission and selects from Common Application Form Data 330 the data required by a specific employer for a specific instance of Employment Opportunities 145. Employer Requirement Logic 340 is optionally configured to notify an applicant of missing or optional information requirements.

Optional QR Scan Logic 350 is configured to interpret QR codes and optionally convert these codes to URLs pointing to web pages including business and/or job descriptions. QR Scan Logic 350 may be disposed on members of Clients 120.

Location Identification logic 355 is configured to automatically detects an applicant's location (e.g., based on the mobile device's GPS functionality) and optionally determine whether a particular business at that location has any open positions. In some embodiments, Employment Application System 110 automatically directs the applicant to the business's webpage wherein the related Employment Opportunities 145 are listed.

Optional Job Board Search Logic 360 includes the logic to both maintain a job board and to search for Employment Opportunities 145 therein. The job board is optionally stored within Memory 130. Applicants can use Job Board Search Logic 360 to search for jobs (e.g., Employment Opportunities 145) posted by employers. The applicants can then apply using other features of Employment Application System 110. The search can be performed based on satisfaction of applicant and/or employer criteria (e.g., job fit), location, destination, business type, etc.

Job Match Logic 365 is configured to analyze requirements of Employment Opportunities 145 and compare these to Applicant Profiles 140. The comparison can result in a “match rank” indicative of the suitability of the application for a job. The information considered can include the applicant's profile, resume, as well as submission history to establish the match rank.

Optional Application Submission Logic 370 is configured for communicating an application package to an employer and optionally for determining an application package's fit to the requirements of an Employment Opportunity 145 as stated by an employer. This logic optionally provides real-time feedback to the applicant, and indicates to the applicant weather their summited application package meets the requirements stated by the employer. The feedback can include a list of gaps and guidance to complete the requirements. Application Submission Logic 370 is optionally part of Application Logic 160.

Application Submission Manager 380 is configured to keep track of application submissions and allows an applicant to review prior submissions. The applicant is able to review the entire application package which is a copy of what had been submitted at the time the request for employment was made. This may include the application (common part and the employer specific), resume, cover letter, and the online profile of the applicant.

FIG. 4 illustrates further components that may be included in Employment Application System 110, according to various embodiments of the invention. These components include: Device Type Detector Logic 410, Business Setup Logic 420, Signup & Payment Logic 430, Job Setup Logic 440, Application Review Logic 450, Submission Logic 460, and/or Submission Analysis Logic 470. These components are optionally configured to allow employers to create a “business career” webpage and present their Employment Opportunities 145 within this webpage. The webpage can also include related information about the business. These components are also configured for the employer to receive custom subsets of Applicant Profiles 140 and related information as part of requests for employment submitted by applicants. The requests for employment typically comprise an employment application package that may include: an employment application (common and job specific as requested by the employer for each of Employment Opportunities 145), a resume, a cover letter, and/or link to an online profile (i.e. a rich media profile). The material received in the application package can be customized by the employer. As such, once an applicant has populated Common Application Form Data 330, those data elements/fields that the employer wishes to see for a particular Employment Opportunity 145 can be specified by the employer. Common Application Form Data 330 can be used to automatically populate a wide variety of different employment application forms having different requirements.

Device Type Detector Logic 410 is configured to automatically detect the type of device that the employer is using to access Employment Application System 110, e.g., a personal computer or a mobile device. Employment Application System 110 then automatically adjusts the output of Employment Application System 110 to provide the best user experience for the particular device (mobile and tablet in both portrait and landscape mode as well as laptop or desktop browsers).

Business Setup Logic 420 is configured to support setup of the business career webpage. Business Setup Logic 420 is optionally further configured for generating a QR code (or other barcode) for a particularly employment facility, or advertisement. Business Setup Logic 420 optionally includes an inline web editor.

Signup & Payment Logic 430 is configured to provide functionality required for business administration (user management, privileges, etc.) as well account level setup and payment methods and processing.

Job Setup Logic 440 is configured for specifying Employment Opportunities 145. Job Setup Logic 440 optionally includes an inline editor that enables easy setup of job requirements as well as its specific requirements and submission information parameters. Job Setup Logic 440 is optionally configured for specifying which data in Common Application Form Data 330 is required and which is optional, for application to a specific member of Employment Opportunities 145.

In some embodiments, Job Setup Logic 440 includes a job editor. The job editor is configured for the employer user to provide a job description for each of Employment Opportunities 145 for that employer, and to configure employment application requirements as well as notification settings. The Job Setup Logic 440 includes logic configured for specifying the required section of the employment application sections as well as the required fields within each section. The employer user is also able to use Job Setup Logic 440 to configure a notification form for every position. Notification configurations include: email notification subject line, email address(s), notification frequency, etc.

Job Setup Logic 440 is optionally further configured to create a placard with a logo and an array of optional help wanted phrasings (i.e. Join our Team, Now Hiring, Want to Work Here, Employment Opportunities). This placard optionally includes a unique QR code that is stored in one of Employment Opportunities 145 in association with that employer and/or a location. The QR code is optionally convertible to a universal resource locator that will direct applicants to the employer's specific business webpage. The placard can be placed at the entry of the establishment to encourage job seekers to inquire and apply. The same QR code and the URL address can be printed on a small business size card so that it can be handed to job seekers.

Application Review Logic 450 is configured for an employer to review an applicant's submissions and disposition the applicant for action (reject, contact, interview, hire, hired, hold, etc.). Application Review Logic 450 is optionally configured to calculate and present a rating of the applicant or a score representative of a match between the applicant and the requirements of one of Employment Opportunities 145.

Submission Logic 460 is configured for managing requests for employment and access to application data at any point in time. This logic optionally maintains a full record of requests for a configurable period of time to comply with federal and local employment laws (typically 2 years). The employer is able to search prior submissions by name, date, employment history, etc.

Submission Analysis Logic 470 is configured to perform compliance and completeness analysis on the application packages received in requests for employment. Additionally, Submission Analysis Logic 470 can be configured to provide information regarding applicant's patterns of applying such as multiple submissions in a short period of time or other activities.

Several embodiments are specifically illustrated and/or described herein. However, it will be appreciated that modifications and variations are covered by the above teachings and within the scope of the appended claims without departing from the spirit and intended scope thereof. For example, the systems and methods described herein may be applied to other types of applications historically made using forms for example, credit applications, rental applications (apartment, housing, auto, etc.), loyalty program applications, school applications, and or the like. Some embodiments of Employment Application System 110 include all the components illustrated in FIGS. 1, 3 and 4.

The embodiments discussed herein are illustrative of the present invention. As these embodiments of the present invention are described with reference to illustrations, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings should not be considered in a limiting sense, as it is understood that the present invention is in no way limited to only the embodiments illustrated. All the logic discussed herein includes hardware, firmware and/or software statically stored on a computer readable medium. This logic may be implemented in an electronic device to produce a special purpose computing system.

Computing systems referred to herein can comprise an integrated circuit, a microprocessor, a personal computer, a server, a distributed computing system, a communication device, a network device, or the like, and various combinations of the same. A computing system may also comprise volatile and/or non-volatile memory such as random access memory (RAM), dynamic random access memory (DRAM), static random access memory (SRAM), magnetic media, optical media, nano-media, a hard drive, a compact disk, a digital versatile disc (DVD), and/or other devices configured for storing analog or digital information, such as in a database. The various examples of logic noted above can comprise hardware, firmware, or software stored on a computer-readable medium, or combinations thereof. A computer-readable medium, as used herein, expressly excludes paper. Computer-implemented steps of the methods noted herein can comprise a set of instructions stored on a computer-readable medium that when executed cause the computing system to perform the steps. A computing system programmed to perform particular functions pursuant to instructions from program software is a special purpose computing system for performing those particular functions. Data that is manipulated by a special purpose computing system while performing those particular functions is at least electronically saved in buffers of the computing system, physically changing the special purpose computing system from one state to the next with each change to the stored data.

What is claimed is:

1. An employment application system comprising:
memory configured to store a common application form;
employer setup logic configured for an employer to select fields of the common application form as being required fields for an employment opportunity;
employer memory configured to store the fields selected by the employer;
applicant setup logic configured for an applicant to enter applicant data in fields of the common application form;
applicant memory configured to store the applicant data as part of an applicant profile;
application submission logic configured to receive a request from the applicant to apply for an employment opportunity offered by the employer, to retrieve the applicant data from the applicant memory, to insert the applicant data in the fields selected by the employer, and to provide the selected fields including the applicant data to the employer; and
a microprocessor configured to execute at least part of the employer setup logic, the applicant setup logic or the application submission logic.

2. The system of claim 1, wherein the employer setup logic is further configured to assign the selected fields to one of a plurality of employment opportunities available from the employer.

3. The system of claim 1, wherein the employer setup logic is further configured to specify one or more fields not included in the common application form as being required fields for the employment opportunity.

4. The system of claim 1, wherein the employer setup logic is further configured to associate the one of a plurality of jobs with one or more specific location.

5. The system of claim 1, wherein the employer setup logic is further configured to associate an employment opportunity available from the employer with a QR code.

6. The system of claim 1, where in the employer memory is further configured to store a plurality of sets of fields selected by the employer, each of the sets being associated with a different job.

7. The system of claim 1, further comprising memory configured to store an employee profile, the employee profile including jobs applied for by the employee using the application submission logic.

8. The system of claim 1, wherein the applicant setup logic is configured to automatically fill one or more of the fields of the common application form based on a previously stored employee profile.

9. The system of claim 1, wherein the application submission logic is further configured to search for jobs offered by employers based on the applicant data and provide information regarding matching employment opportunities to the applicant.

10. The system of claim 1, wherein the application submission logic is further configured to retrieve the applicant data using an identifier received in the request.

11. The system of claim 1, wherein the application submission logic is further configured to identify the employer using a source identifier included in the request.

12. The system of claim 1, further comprising logic is configured to detect a location of the applicant and automatically display a list of businesses that have nearby employment opportunities.

13. An employment application server comprising:
an I/O configured to communicate to and from a remote client;
first memory including a data structure configured to store a plurality of applicant profiles;
second memory including a data structure configured to store a plurality of employment opportunities offered by a plurality of employers;
third memory including a data structure configured to store a plurality of source identifiers, each of the source identifiers being associated with at least one of the employers and being associated with a location;
listing logic configured to receive a request for employment opportunities, to retrieve the requested employment opportunities from the second memory, and to provide the retrieved employment opportunities to the remote client, the request for employment opportunities being received along with source information configured to identify a location of the remote client;
application logic configured to receive a request for employment from the remote client, the request being in response to one of the retrieved employment opportunities, and further configured to retrieve a first of the plurality of applicant profiles from the first memory and to send the first of the plurality of applicant profiles to an employer in response to receiving the request for employment, the one of the retrieved employment opportunities being for employment at the employer; and
a microprocessor configured to execute at least the listing logic.

14. The server of claim 13, further comprising selection logic configured to select another employment opportunity and automatically provide the selected employment listing to the remote client, the selection of another employment opportunity being based on the location of the remote client.

15. The server of claim 13, further comprising source logic configured to determine the location of the remote client based on the source information.

16. The server of claim 13, wherein the listing logic is configured to retrieve the requested employment opportunities based on the location of the remote client.

17. A method of providing location based employment information, the method comprising:
receiving, via a communication network, an applicant profile including information characterizing a person;
storing the applicant profile in a memory, the memory including a data structure configured to store multiple applicant profiles;
receiving a request for one or more employment opportunities from a remote client, the request including source information;
identifying a location of the client device based on the source information;
retrieving the one or more employment opportunities from a computer memory, the computer memory including a data structure configured to store multiple employment opportunities, retrieval of the one or more employment opportunities being based on the location of the client device;
providing to the client device the one or more employment opportunities, the one or more employment opportunities including an employment opportunity at a facility proximate to the location of the client device;
receiving a first request for employment the client device, the first request being responsive to the employment opportunity at the facility proximate to the location of the client; and
providing the applicant profile to an employer associated with the employment opportunity at the facility.

18. The method of claim 17, wherein the location of the user is determined using global positioning system information received from the client device.

19. The method of claim 17, wherein the location of the client device is determined using cellular data.

20. The method of claim 17, wherein the location of the client is determined using barcode data.

21. The method of claim 17, further including comparing the source information to a source identifier, wherein the source identifier includes the location of an employment facility.
